(19) United States
(12) Patent Application Publication
(10) Pub. No.: US 2019/0316581 A1
(43) Pub. Date: Oct. 17, 2019

(54) PUMP VALVE WITH SEAL RETAINING STRUCTURE

(71) Applicant: TSC Manufacturing and Supply, LLC, Houston, TX (US)

(72) Inventors: Jianke WANG, Conroe, TX (US); Daniel Brent JOHNSON, Houston, TX (US); Ram THIAGARAJAN, Missouri City, TX (US); Xiaonan ZHAI, Houston, TX (US); Shaolin WU, Qingdao City (CN); Yanxia WANG, Qingdao City (CN)

(21) Appl. No.: 16/381,080

(22) Filed: Apr. 11, 2019

Related U.S. Application Data
(60) Provisional application No. 62/657,044, filed on Apr. 13, 2018.

(51) Int. Cl. F04B 53/12; F04B 47/00; F16K 1/20; F04B 53/14; F16J 15/3284

(52) U.S. Cl. CPC F04B 53/127; F04B 47/00; F04B 53/1087; F04B 53/143; F16J 15/3284; F16K 1/205

(57) ABSTRACT

The disclosure herein generally relates to sealing elements for valves and methods for forming the same. A valve component has a body which includes a guide portion, a stem, and a sealing portion between the guide portion and the stem. The sealing portion has a front surface facing the guide portion, a back surface facing the stem, and a recess for a sealing element formed in a periphery of the sealing portion; and one or more passages extending between the back surface of the sealing portion and the recess.

### CROSS-REFERENCE TO RELATED APPLICATIONS

This application claims benefit of U.S. Provisional Patent Application Ser. No. 62/657,044, filed Apr. 13, 2018, which is incorporated herein by reference.

### FIELD

Embodiments of the present disclosure generally relate to sealing elements for valves and methods of forming the same.

### BACKGROUND

In oilfield operations, reciprocating pumps are used for different applications such as drilling and hydraulic fracturing of subterranean formations. Generally, a reciprocating pump includes one or more piston or plunger assemblies to increase the pressure of a fluid being pumped therethrough. A simple piston or plunger assembly includes a housing with a cylindrical opening formed therein. A piston or plunger is disposed in the cylindrical opening to create a cavity. The cavity is in fluid communication with an inlet port and an outlet port. A valve is disposed respectively within the inlet port and the outlet port. The valves operate alternatively to allow fluid into the cavity, the fluid to be pressurized by motion of the piston or plunger, and removed from the cavity. Reciprocating pumps are commonly operated at pressures of 3,000 pounds per square inch (psi) and upward to 25,000 psi. A reciprocating pump designed for fracturing operations is commonly known as a “frac pump.” Similarly, a pump may be commonly known as “mud pump” for drilling applications.

In order to provide a strong seal between the valve and the piston assembly, a seal element is commonly disposed on the valve. The seal is an element formed from a compliant material that seats between the valve and a seating surface to prevent fluid leaking through the seal. The seal must be able to withstand the differential pressure across the seating area. However, due to the high pressures involved with frac pumps and mud pumps, these seals commonly fail prematurely and/or unseat from the valve. Therefore, an improved design of seals for frac pumps and mud pumps is needed.

### SUMMARY

Embodiments described herein provide a valve component for a reciprocating pump, comprising a body, the body comprising a guide portion, a stem, and a sealing portion between the guide portion and the stem, the sealing portion having a front surface facing the guide portion, a back surface facing the stem, and a recess for a sealing element formed in a periphery of the sealing portion, and one or more passages extending between the back surface of the sealing portion and the recess.

Other embodiments provide a valve component, comprising a disc shaped body, a sealing element disposed within an annular retaining recess formed around an outer circumference of the disc shaped body, and a plurality of passages formed from the recess to an outer surface of the body.

Other embodiments provide a method of forming a seal on a valve component, comprising flowing a precursor material into a peripheral recess formed around the circumference of a disc shaped body, wherein one or more passages extend from the recess to an outer surface of the disc shaped body; evacuating gas from the recess through the passages while flowing the precursor material into the recess; and curing the precursor material to form the seal.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a perspective view of a valve component according to one embodiment.

FIG. 2A is a partial cross-section of the valve component of FIG. 1.

FIG. 2B is an enlarged view of a portion of the cross-section of FIG. 2A.

FIG. 2C is an enlarged view of a portion of a valve component according to another embodiment.

FIG. 3A is a partial cross section of a valve component according to another embodiment.

FIG. 3B is an enlarged view of a portion of the cross-section of FIG. 3A.

FIG. 3C is an enlarged view of a portion of a valve component according to another embodiment.

FIG. 4 is a plan view of a valve component according to another embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The disclosure herein generally relates to sealing elements for valves and methods for forming the same. A valve component has a body which includes a guide portion and a sealing portion. The sealing portion is a generally disc shaped body that includes a recess formed around the periphery thereof. The recess forms a protrusion at each edge thereof which engages with a sealing element disposed in the recess to retain the sealing element therein. A plurality of passages extends from the recess to an outer surface of the sealing portion. The passages function to retain the sealing element in the recess and evacuate gases trapped by the sealing element during formation thereof.

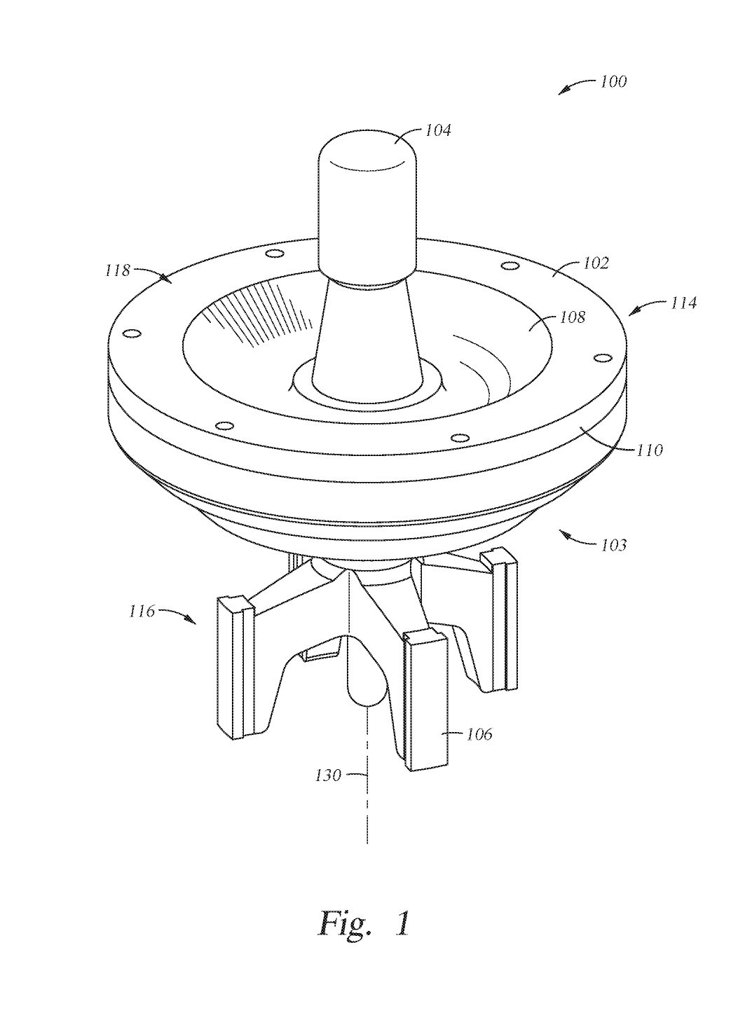

FIG. 1 is a perspective view of a valve component 100 according to one embodiment. The valve component 100 has a body 102. The body 102 includes a sealing portion 114 and a guide portion 116. Here, the sealing portion 114 is a disc shaped body. A stem 104 extends representatively upward, in the orientation shown in FIG. 1, from the sealing portion 114, so that the sealing portion is between the guide portion and the stem. The valve component 100 has an axis 130 through a center of the sealing portion 114 and through the stem 104. The sealing portion 114 has a front surface 103 (not visible in FIG. 1), which faces the guide portion 116, and a back surface 118, which faces the stem 104.

The guide portion 116 is coupled to, and extends representatively downward from, the front surface 103 of the sealing portion 114. The guide portion 116 includes a plurality of guides 106 coupled to the sealing portion 114. The guides 106 are arranged radially about, and extending laterally away from, the axis 130 of the valve component 100. Here, four guides 106 are evenly distributed around the axis 130 of the valve component 100. However, other numbers, such as two, three, five, or even more, may be utilized herewith.

The body 102 is generally formed from a forged or cast metal, such as carbon steel, stainless steel, or alloy materials, among others. In one embodiment, the sealing portion 114 and the guide portion 116 of the body 102 are formed as separate components and then joined together, such as, by welding. In another embodiment, the sealing portion 114 and the guide portion 116 are formed as a unitary body.

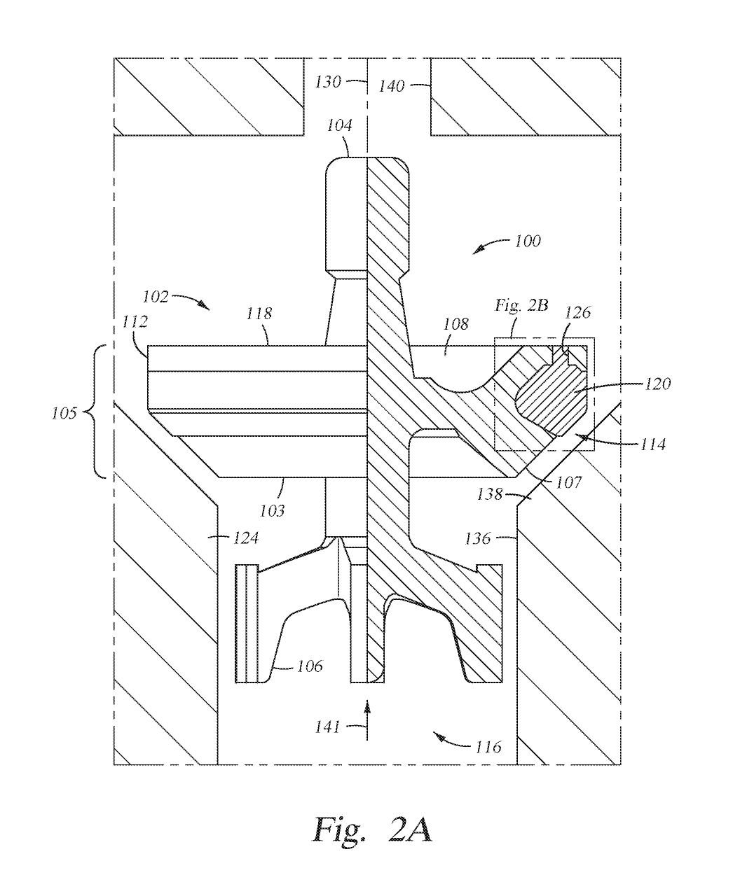

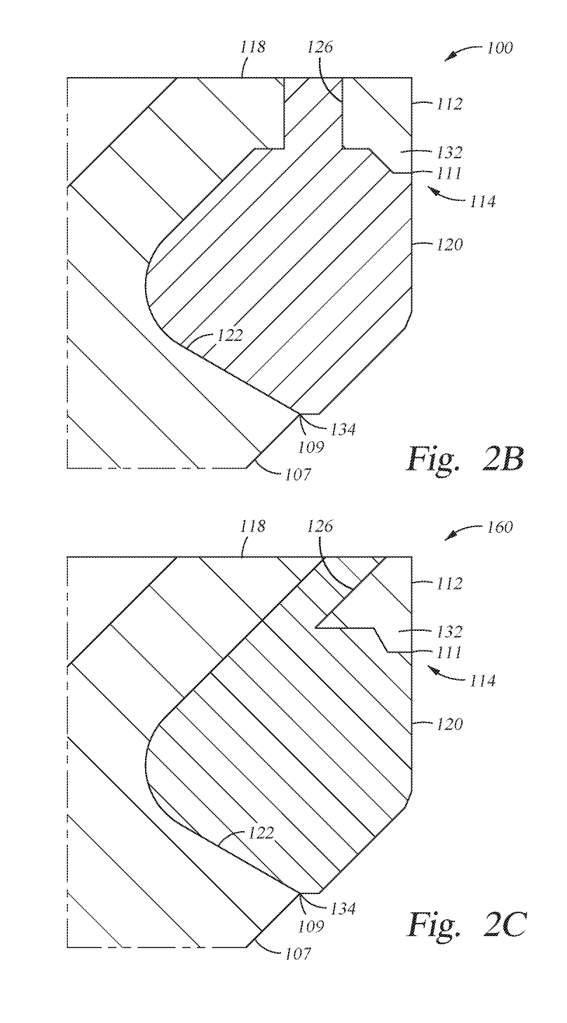

FIG. 2A is a partial cross-section of the valve component of FIG. 1. Here, the valve component 100 is shown disposed in a valve seat 124 of a frac pump or mud pump. A spring retaining groove 108 is formed in the sealing portion 114 of the body 102 surrounding the stem 104, on the back surface 118 thereof. In operation, a coil spring (or other resilient member, not shown) is disposed around the stem 104 and retained by the spring retaining groove 108. The coil spring generates a spring force onto the valve component 100 in order to bias the valve component 100 towards the valve seat 124. The operation of the valve component 100, including the spring, will be described in detail herein in relation to FIGS. 2A and 2B.

Referring to FIGS. 2A and 2B, a sealing element 120 is disposed in a circumferential recess 122 formed in the sealing portion 114. The sealing portion 114 has a side surface 105 that extends between the front surface 103 and the back surface 118. An outer portion 112 of the side surface 105 forms an edge with the back surface 118, while a sloped portion 107 of the side surface 105 connects to the front surface 103. The recess 122 is formed in the sloped portion 107, the outer portion 112, or in this case both the outer portion 112 and the sloped portion 107.

The sealing element 120 is formed from a material which is resistant to degradation from exposure to the fluid pumped by the frac pump or mud pump and from contact force between the sealing element 120 and the valve seat 124. The sealing element 120 is formed from materials that resist degradation and have desired sealing properties, such as elastomers and/or thermoplastic polymers. Examples of materials that can be used for the sealing element 120 include polyurethane, rubber, polytetrafluoroethylene (PTFE), DELRIN® (polyoxymethylene), polyetheretherketone (PEEK), neoprene, nylon, polyurea, polyisocyanurate, polycyanurate, and epoxy resin among others. The material is selected in relation to the service conditions and fluid properties used therewith, such as viscosity, abrasion, temperature, pressure, and corrosion, among others.

FIG. 2B is an enlarged portion of the valve component 100 showing the sealing element 120. As shown, the recess 122 is formed as a semi-arcuate channel in the outer portion 112 and the sloped portion 107, around the periphery of the sealing portion 114. The recess 122 has an inner edge 109 where the recess 122 connects to the sloped portion 107 and an outer edge 111 where the recess 122 connects to the outer portion 112. At the inner and outer edges 109 and 111 of the recess 122, two protrusions 132, 134 are respectively formed. The protrusions 132, 134 retain the sealing element 120 within the recess 122 as further described below.

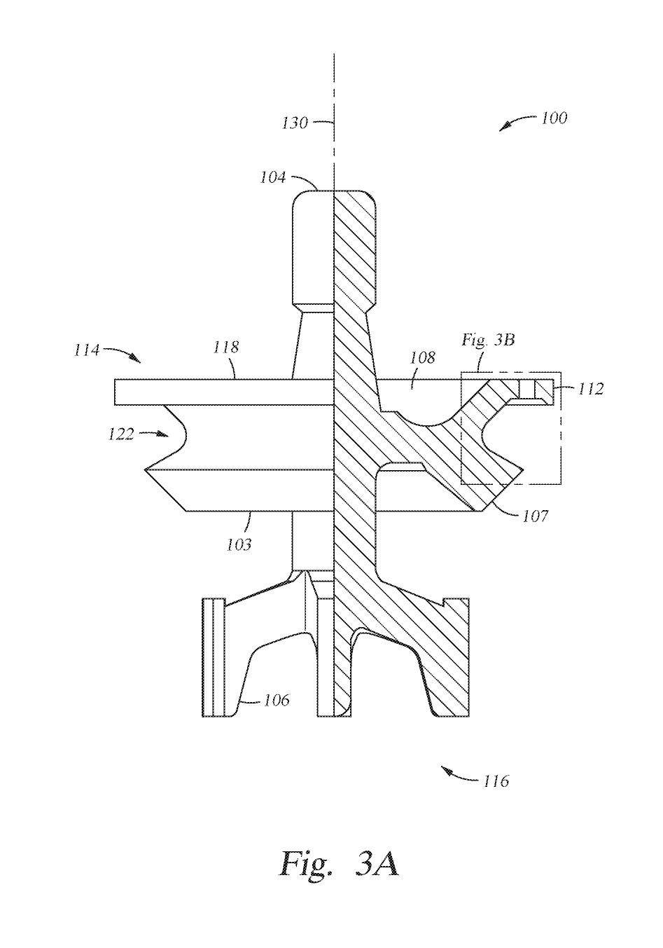

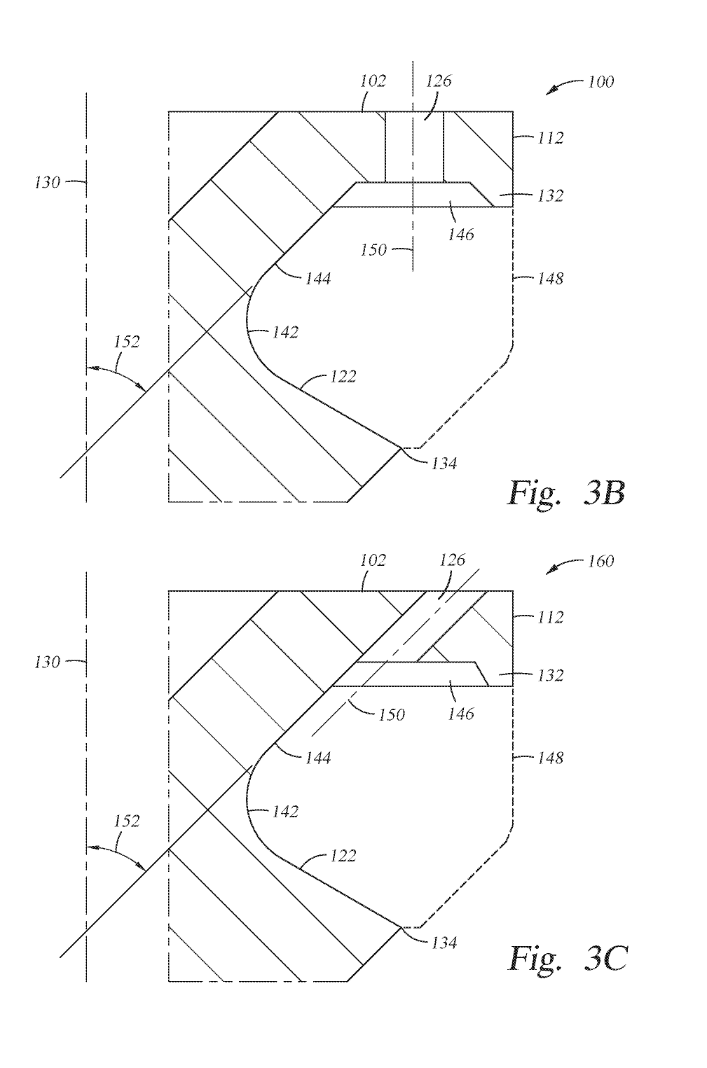

The sealing portion 114 has a plurality of passages extending between the recess 122 and the back surface 118 of the sealing portion 114. FIG. 2B illustrates one of the passages 126 extending between the recess 122 and the back surface 118 of the sealing portion 114. The passages 126 are disposed in the sealing portion 114 about the axis 130 (FIG. 2A) of the valve component 100. The passages 126, in combination with the recess 122 and the protrusions 132, 134, function to retain the sealing element 120 within the recess 122. The passages 126 also aid in manufacturing the valve component 100 as described below in relation to FIGS. 3A, 3B, and 3C.

In operation, the valve component 100 is disposed in a port, such as an inlet port or an outlet port, of a frac pump or mud pump. The valve seat 124 is also disposed in the port in advance. Referring back to FIG. 2A, a representative valve seat 124 is shown. The valve seat 124 includes a cylindrical wall 136 connecting to a tapered opening 138. The cylindrical wall 136 has a diameter that is substantially equal to a smallest diameter of the tapered opening 138. The valve seat 124 is, for example, designed in accordance with American Petroleum Institute (API) standards or other desired design.

The guide portion 116 is disposed representatively below the sealing portion 114, extending from the front surface 103 thereof. In this embodiment, the guides 106 are radially extending members coupled a central hub or shaft. In this embodiment, a radially outward surface of each guide 106 extends parallel to the axis 130 of the valve component 100. The guides 106 are sized to fit within the cylindrical wall 136 of the valve seat 124. The guides 106 engage with the cylindrical wall 136 to concentrically align the valve component 100 with the valve seat 124. The radially outward surfaces of the guides 106 which engage the cylindrical wall 136 have a smooth machined surface in order to minimize friction. In FIG. 2A, a gap between the guides 106 and the cylindrical wall 136 is exaggerated for clarity. The gap between the guides 106 and the cylindrical wall 136 is selected to provide a desired clearance therebetween.

As discussed above, a spring (not shown) is disposed surrounding the stem 104 within the spring retaining groove 108 on the back surface 118 of the sealing portion 114. A stem guide 140 is disposed proximate to the valve component 100 opposite from the valve seat 124. The stem guide 140 includes an opening sized for insertion of the stem 104 therein. The opening in the stem guide 140 engages with a portion of the stem 104 in order to align the valve component 100 and guide the valve component 100 during movement from an open position to a closed position, and vice versa. The spring (not shown) is held between the stem guide 140 and the valve component 100.

In a valve closed position, the sealing element 120 is pressed against the tapered opening 138 of the valve seat 124, which functions as a sealing surface. Therefore, contact between the sealing element 120 and the tapered opening 138 creates a seal preventing backflow of a fluid in the direction opposite of that depicted by arrow 141. The spring provides a force urging the valve component 100 towards the tapered opening 138 to counteract a pressure differential across the sealing portion 114. That is, the spring biases the valve component 100 towards the valve seat 124 to a closed position and resists pressure of the fluid in the flow direction 141. In the valve closed position, the sealing element 120 is compressed between the recess 122 and the tapered opening 138 of the valve seat 124. The compression results in a shear force on the sealing element 120, which shears the sealing element 120 towards the outer portion 112. The protrusion 132 (FIG. 2B) counters the shear force on the sealing element 120, providing an opposing retaining force that retains the sealing element 120 within the recess 122. The protrusion 134 likewise counteracts spreading of the sealing element 120 during compression thereof by an opposing retaining force.

In a valve open position, the sealing element 120 is spaced away from the tapered opening 138 forming a flow path between the sealing portion 114 and the valve seat 124 through which a fluid flows in the flow direction 141. As the fluid flows past the sealing element 120, fluid pressure and friction forces on the sealing element 120 bias the sealing element away from the recess 122. The protrusion 132 also resists these fluid forces and, thus, retains the sealing element 120 within the recess 122.

The shapes of the sealing element 120 and the valve seat 124 shown in FIGS. 2A and 2B are examples. The embodiments described herein may be utilized with other shapes and designs of the sealing element 120, the recess 122, and the valve seat 124. For example, the embodiments of the disclosure may be utilized with other API standard valve seats or valve types. The embodiments herein are also not limited to frac pump and/or mud pump valve applications. The disclosure may be utilized with other valve and/or sealing types.

FIG. 2C is an enlarged view of a valve component 160 according to another embodiment. The valve component 160 is similar to the valve component 100. The valve component 160, however, has a different configuration of passages 126 from the valve component 100. Specifically, whereas the valve component 100 of FIG. 2B has passages 126 that have an axis 150 that is parallel to the axis 130, the passages 126 of the valve component 160 have an axis 150 that forms an angle of 45 degrees with the axis 130. The angle between the axis 150 and the axis 130 may be from zero degrees to 90 degrees, such as from about 10 degrees to about 80 degrees, for example 45 degrees, as in FIG. 2C. In this case, the contact surface of the sealing element 120 is formed with a slope that is substantially equal to the axis angle of the passage 126. Such a configuration provides alignment of the shear force experienced at the surface of the sealing element 120 when seated against the tapered opening 138 of the valve seat 124 along the axis of the passage 126 to provide maximum benefit of frictional forces within the passage 126 to stabilize the sealing element 120 in the recess 122.

FIGS. 3A and 3B illustrate the valve component 100 with the sealing element 120 removed from the recess 122 to illustrate the structure of the recess 122. The recess 122 has a profile in cross-section with a curved portion 142 and a connected linear portion 144. The curved portion 142 and the linear portion 144 form surfaces of the recess 122 that each circumnavigate the central axis 130 of the valve component 100.

Each of the passages 126 open into a respective counter bore 146 formed adjacent to the linear portion 144, between the linear portion 144 and the protrusion 132. The counter bores 146 provide an additional mechanism for retaining the sealing element 120 within the recess 122. The counter bores 146 and the passages 126 also aid in forming the sealing element 120 as described below. The passage 126 shown in FIG. 3B is substantially cylindrical and as noted above, has an axis 150 that is parallel to the axis 130, forming an angle of zero degrees with the axis 130. The passages 126 can, instead, be non-straight, for example curved or bent. As also noted above, the axis 150 of each passage 126 can form an angle with the axis 130 that is from zero to 90 degrees, for example from 10 to 80 degrees. The passages 126 are shown as having constant diameter, but the diameter of each passage 126 may vary, continuously, linearly, discontinuously, step-wise, or according to any desired shape, along the passage 126. Combinations of the above features may also be used.

FIG. 3C is an enlarged view of the valve component 160 of FIG. 2C without the sealing element 120. The valve component 160 has a recess 122 with an angled linear profile portion 144. The linear portion 144 of the valve component 160 forms an angle of 45 degrees with the axis 130. As noted above in connection with FIG. 2C, the passages 126 of the valve component 160 have an axis 150 that forms an angle of 45 degrees with the axis 130. Thus, the angle of the passages 126 is substantially equal to the slope of the linear portion 144. The angle of the linear portion 144 with respect to the axis 130 may be from zero degrees (i.e. essentially vertical, or parallel to the axis 130) to about 60 degrees, and depends on the shape of the recess 122. An angled linear portion 144 provides increased contact surface area between the sealing element 120 and the recess 122, and also provides reduced shear between the sealing element 120 and the recess 122 to minimize the possibility of shear dislocation of the sealing element 120 during operation.

In an example process, the sealing element 120 is formed in the recess 122 using a molding method. First, a flowable material used for the sealing element 120 is formed. The flowable materials may be, for example, heated or solvated in order to allow the fluid to readily flow. The material for the sealing element 120 is a precursor that sets or hardens in the recess 122 to form the sealing element 120.

A form is coupled to the body 102 before or after adding the precursor to the recess 122. The form partially defines the profile of the sealing element 120. Here, a form 148 is shown schematically in FIG. 3B indicated by the dashed line outlining the location of the sealing element 120. When the form is coupled to the body 102 before adding the precursor material, the flowable precursor material is injected into the recess 122 between the form and the body 102. A bonding material is optionally disposed onto one or more surfaces of the recess, such as 132, 134 142, 144, and 146, and the passages 126, prior to injection of the material of the sealing element. The bonding materials provide additional adhesion between the recess 122 and the sealing element 120 to retain the sealing element 120 therein after forming. After injection, the material is cured and/or set in place to form the sealing element 120.

In conventional techniques, air and/or other gases are commonly trapped in the recess 122 as the precursor material for the sealing element 120 is poured therein. Air pockets are formed by the trapped gases which cause defects in the sealing element 120. For example, air pockets reduce the adhesion between the sealing element 120 and the recess 122 by reducing contact surface area between the sealing element 120 and the recess 122. Additionally, air pockets and local deformations can cause stress concentrations which lead to premature failure of the sealing element 120 during loading and cycling thereof. However, by using the embodiments described herein, the passages 126 and the counter bore 146 provide a vent path to exhaust such gases thereby preventing formation of air pockets due to trapped gases. Therefore, the embodiments herein advantageously increase the life and performance of the sealing element 120.

It is to be understood that other methods of forming the sealing element 120 may be utilized herewith. Other methods include, but are not limited to, vacuum molding, casting, injection, bonding, extrusion, and void filling. The embodiments described herein may be advantageously utilized with any manufacturing technique where the prevention of trapping gases is desired.

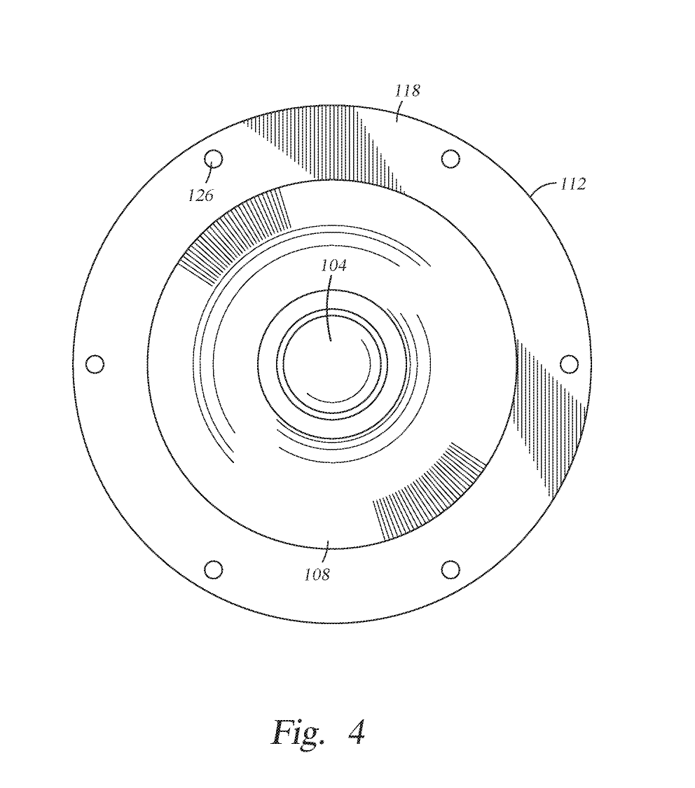

FIG. 4 is a plan view of the valve assembly 100. Here, the passages 126 are disposed around the body 102. Six passages 126 are shown in FIG. 4 and are uniformly distributed in a polar array. However, the location and design of the passages 126 are selected in relation to the design and method of forming the sealing element 120. For example, more or less passages 126 may, such as one, two, three, four, five, seven, eight, nine, ten, or even more, be used to exhaust trapped gases and/or prevent the sealing element 120 from dislodging during compression thereof. The shape of the passages 126 is also may differ. For example, the passages 126 may be arcuate, slot, square, hexagon, or other geometries.

Further, the orientation and size of the passages 126 may be changed. For example, the passages 126 of FIGS. 2A, 2B, 3A, and 3B are shown, each with an axis substantially normal to the back surface 118 of the sealing portion 114 (i.e. parallel to the axis 130, forming an angle of zero degrees with the axis 130). However, the passages 126 may extend at an angle between about 0 degrees to about 90 degrees measured relative to the axis 130. The orientation and layout of the passages 126 is selected in relation to the design of the sealing element 120 and/or the design of the body 102.

In general, the size of the passages 126 is not particularly limited. The passages 126 need to be large enough to allow gas to escape while precursor material for the sealing element 120 is being charged to the recess 122, and small enough to not compromise the overall structural integrity of the valve component 100. The passages 126 may be larger overall for larger sized valve components. For example, in a valve component nominally 6 inches in size (i.e. the maximum transverse diameter of the sealing portion 114 is nominally 6 inches), the passages may be from about 0.04 inches in diameter up to about 1.75 inches in diameter. Note that the structure of the valve component 100 may also influence the maximum size of the passages 126 and the recess 122. Specifically, the valve component 100 has a distance profile between the spring retaining groove 108 and the outer portion 112 of the side surface 105 of the sealing portion 114. The distance profile governs the size of the recess 122 that will fit into the sealing portion 114, and also governs the size of the passages 126 that can be used.

The embodiments described herein advantageously increase the life and performance of a sealing element used in a valve. The disclosure enables increased performance in the sealing element by preventing dislodging and/or failure thereof due to cyclic compression thereof. Further, the embodiments describe herein improve the manufacturing of a sealing element by preventing local deformations due to trapped gases during the formation of the sealing element.

While the foregoing is directed to embodiments of the present disclosure, other and further embodiments of the disclosure may be devised without departing from the basic scope thereof, and the scope thereof is determined by the claims that follow.

What is claimed is:

1. A valve component for a reciprocating pump,
comprising: a body, the body comprising:
a guide
portion; a
stem; and
a sealing portion between the guide portion and the stem, the sealing portion having a front surface facing the guide portion, a back surface facing the stem, and a recess for a sealing element formed in a periphery of the sealing portion; and
one or more passages extending between the back surface of the sealing portion and the recess.

2. The valve component of claim 1, wherein the recess is a channel formed around the circumference of the sealing portion, the channel having a protrusion on each side thereof.

3. The valve component of claim 1, wherein the channel has a profile with a curved portion connected to a linear portion.

4. The valve component of claim 1, wherein the body has a central axis, and each passage has an axis that forms an angle between about 10 degrees and about 80 degrees with the axis of the body.

5. The valve component of claim 1, wherein a sealing element is disposed in the recess.

6. The valve component of claim 2, wherein a sealing element is disposed in the recess and the sealing element is retained within the recess by the protrusions.

7. The valve component of claim 5, wherein the sealing element is formed from a polymer.

8. The valve component of claim 5, wherein a bonding material is disposed between the sealing element and the recess.

9. The valve component of claim 1, wherein each passage is cylindrical, arcuate, or slotted.

10. A valve component,
comprising: a disc shaped body;
a sealing element disposed within an annular retaining recess formed around an outer circumference of the disc shaped body; and
a plurality of passages formed from the recess to an outer surface of the body.

11. The valve component of claim 10, wherein a protrusion is formed at an outer edge of the recess.

12. The valve component of claim 11, wherein the passages and the protrusion retain the sealing element within the recess.

13. The valve component of claim 10, wherein the disc shaped body has an axis, and each passage has an axis that forms at an angle between about 10 degrees and about 80 degrees with the axis of the disc shaped body.

14. The valve component of claim 10, further comprising:
one or more guides coupled to the body, where in each guide is a member extending radially from a central hub; and
a valve stem coupled to the disc shaped body.

15. The valve component of claim 10, wherein the sealing element is formed from a polymer.

16. The valve component of claim 10, wherein a bonding material is disposed between the recess and the sealing element.

17. The valve component of claim 10, wherein each passage is cylindrical, arcuate, or slotted.

18. A method of forming a seal on a valve component, comprising:
flowing a precursor material into a peripheral recess formed around the circumference of a disc shaped body, wherein one or more passages extend from the recess to an outer surface of the disc shaped body;
evacuating gas from the recess through the passages while flowing the precursor material into the recess; and
curing the precursor material to form the seal.

19. The method of claim 18, wherein the seal is made from a polymer.

20. The method of claim 19, wherein the polymer comprises polyurethane, polyurea, polyisocyanurate, polycyanurate, epoxy resin, vulcanized rubber.
